(19) United States
(12) Patent Application Publication
(10) Pub. No.: US 2015/0172472 A1
(43) Pub. Date: Jun. 18, 2015

(54) Credit Request

(71) Applicant: Vitali Straßer, Hadamar (DE)

(72) Inventor: Vitali Straßer, Hadamar (DE)

(73) Assignee: PEACHES MOBILE GMBH, Wiesbaden (DE)

(21) Appl. No.: 14/634,341

(22) Filed: Feb. 27, 2015

Related U.S. Application Data
(63) Continuation of application No. PCT/EP2012/067193, filed on Sep. 4, 2012.

(51) Int. Cl. H04M 15/00; H04M 17/00

(52) U.S. Cl. CPC H04M 15/854; H04M 17/10; H04M 15/67; H04M 15/885

(57) ABSTRACT

The invention relates to an application which is executable on a telecommunications terminal device (100) and which is configured to transmit a command which is invokable by said application (104) and which is suited to cause transmission of a message from said telecommunications terminal device (100) to a server (203), wherein said message is suited, after said message is received by said server (203), to initiate transmission of information relating to a credit which is available to a user of said telecommunications terminal device (100) by said server (203) to said telecommunications terminal device (100).

The invention further relates to a telecommunications terminal device having a corresponding application, a data carrier device on which a corresponding application is stored and a corresponding method.

### CROSS-REFERENCE TO RELATED PATENT APPLICATIONS

This patent application is a continuation of PCT/EP2012/067193, filed on Sep. 4, 2012, the entire teachings and disclosure of which are incorporated herein by reference thereto.

### FIELD OF THE INVENTION

The invention relates to the request for information relating to a credit which is available to a user of a telecommunications terminal device.

### BACKGROUND OF THE INVENTION

By means of a telecommunications terminal device, cost-incurring offers can be taken up. These offers may be services, for example, message services, such as, for example, telephone calls, but also payments in-kind which are obtained by means of the telecommunications terminal device. There are different possibilities for payment of the costs incurred thereby. In this instance, a distinction is made between those types of payment in which a corresponding payment already has to be made before an offer is taken up (Prepaid) and those types of payment in which payment has to be made only after the offer is taken up (Postpaid).

In the case of the prepaid payment, a credit is generally obtained before the respective offer is taken up. In many cases, the credit obtained is not identical to the costs of the offer which is being taken up. For example, before taking up telecommunications services, for example, telephone services by means of a mobile telephone, a specific credit is obtained. That credit is often not used up by a single telephone call. Since a customer of the telephone service provider usually does not precisely monitor or even note the resultant costs, it is often unclear to the customer what credit currently remains for him. Uncertainty with regard to the remaining credit may also result simply in that the acquisition of the credit took place some time ago, without an offer being taken up after the acquisition of the credit.

Against this background, it is necessary to provide users of telecommunications terminal devices with a possibility of being able to acquire information relating to their current credit for taking up cost-incurring offers.

In accordance with a known technical solution, a user of a telecommunications terminal device who would like to obtain information relating to his credit inputs a command in his telecommunications terminal device. That command can be transmitted via a telecommunications network to a server which is configured for processing the command and can be processed there. The credit can be determined by the server and credit information can be transmitted back to the telecommunications terminal device. There, the credit can subsequently be displayed.

Generally, the command which has to be input by a user at his telecommunications terminal device in order to initiate the credit request is not very easily remembered. Therefore, inputting the command is troublesome and prone to error.

### SUMMARY OF THE INVENTION

An object of the present invention is to make it easier to request information relating to a credit which is available to the user of a telecommunications terminal device.

This object is achieved by an application which is executable on a telecommunications terminal device and which is configured to transmit a command which is invokable by the application and which is suited to cause transmission of a message from the telecommunications terminal device to a server, wherein the message is suited, after the message is received by the server, to initiate transmission of information relating to a credit which is available to a user of the telecommunications terminal device by the server to the telecommunications terminal device.

This object is further achieved by a telecommunications terminal device, on which a corresponding application is provided.

The object is further achieved by a data carrier device on which a corresponding application is stored.

Finally, the object is achieved by a method comprising transmitting a command, which is invokeable by an application which is executed on a telecommunications terminal device, by the application, wherein the command is suited to cause transmission of a message from the telecommunications terminal device to a server, and wherein the message is suited, after the message is received by the server, to initiate transmission of information relating to a credit which is available to a user of the telecommunications terminal device by the server to the telecommunications terminal device.

The invention is explained below for the sake of clarity mainly with reference to the application according to the invention. However, the explanations also relate accordingly to the telecommunications terminal device according to the invention, the data carrier device according to the invention and the method according to the invention.

In that the command which is suited to cause the transmission of a message from the telecommunications terminal device to a server, wherein the message is suited, when the message is received by the server, to initiate the transmission of information relating to a credit which is available to a user of the telecommunications terminal device by the server to the telecommunications terminal device, is invokeable by the application, it may not be necessary for the user to manually input a command in the telecommunications terminal device in order thus to cause a transmission of a corresponding message to the server. The comfort for the user may increase. Errors during the manual input may be avoided.

According to the invention, the telecommunications terminal device may be any telecommunications terminal device by means of which a cost-incurring offer can be taken up. In particular, the telecommunications terminal device may be a telecommunications terminal device which is configured for bi-directional communication, that is to say, which allows both the transmission and receipt of information. The telecommunications terminal device may be, for example, a telephone terminal device which allows the use of telephone services. For example, the telecommunications terminal device may be a mobile telephone terminal device. For instance, the telecommunications terminal device may be a mobile telephone, in particular a smartphone.

However, the telecommunications terminal device may also be a device other than a telephone terminal device. Other examples of telecommunications terminal devices include inter alia PCs (personal computers), tablet PCs and other types of portable PCs (notebooks/laptops), Personal Digital Assistants (PDA), games consoles, set-top boxes, etcetera, which have telecommunications functions. The telecommunications functions may be implemented, for example, in that a wireless or wire-based connection to a network, in particular also a connection to the Internet, is establishable by means of the telecommunications terminal device.

The application may be loaded in a memory, for example, a memory having random access (Random Access Memory, RAM) and may comprise programme code for transmitting a command which is invokable by the application and which is suited to cause transmission of a message from the telecommunications terminal device to a server, wherein the message is suited, after the message is received by the server, to initiate transmission of information relating to a credit which is available to a user of the telecommunications terminal device by the server to the telecommunications terminal device, when the programme code is executed by a processor.

The application may be able to be distributed, for example, via a network such as the Internet, a telephone or mobile radio network and/or a local network. The application may be at least partially software and/or firmware of a processor.

The application according to the invention may be stored, for example, on a computer-readable storage medium, for example, a magnetic, electrical, electromagnetic, optical storage medium and/or a storage medium of another type. The storage medium may be, for example, part of the processor, for example, a (non-volatile or volatile) programme memory of the processor or part thereof.

Applications which are provided on a smartphone or tablet PC are often referred to as Apps.

The command which is invokable by the application may be a parameter. Transmitting the command may mean, for example, that a specific routine of the application itself or another computer programme is invoked, to which the command is passed. So that the application can transmit the command, it must have invoked the command previously so that, when transmitting the command is being discussed, it is implied that the application also actually invokes the command which is invokable by the application.

The fact that the command can is invokable by the application may mean in particular that the application can access the command without any intervention of a user, that is to say, without user interaction or automatically. For example, the command may be stored in a memory together with the programme code of the application. The command may have been provided by the provider of the application together with the application. Alternatively, the command which is invokable by the application may also be input once by a user of the telecommunications terminal device during a configuration step of the application, for instance after the first start of the application after the installation thereof on the telecommunications terminal device, and may then be stored by the application so that it is available to be invoked again after the configuration step has been concluded. The command may also be able to be invoked from an external source, for example, from the Internet, by the application.

The message whose transmission from the telecommunications terminal device to the server is caused by transmitting the command by the application may be identical to the command so that the formulation could also be used that the command is transmitted to the server. The command may be part of the message and the message may further comprise additional content in addition to the command. Similarly, only a portion of the command may be part of the message or the message may be transmitted as a reaction to the command and consequently be interpreted as proof for transmitting the command, but ultimately not contain any components of the message itself. The message may comprise an identification which is associated with the telecommunications terminal device and/or the user thereof so that the message can be associated with the user and/or the telecommunications terminal device. This may allow the selective transmission of the information relating to a credit which is available to the user of the telecommunications terminal device directly to the telecommunications terminal device, from which the message was transmitted.

Causing the transmission of the message may be brought about, for example, in that the application invokes a routine of a software programme during the transmission of the command via a software interface of this software programme which runs on the telecommunications terminal device, whereupon the software programme causes the message to be transmitted from the telecommunications terminal device to the server. The software programme may be an operating system of the telecommunications terminal device or another application. Alternatively, the application itself may also cause the transmission without accessing another software programme to that end. For this purpose, it may be configured to generate a suitable message and thus to use corresponding hardware resources of the telecommunications terminal device in such a manner that they carry out the physical message transmission to the server.

The message may be transmitted to the server in particular via a telecommunications network. It may be in particular a telecommunications network which can also be used for purposes other than to transmit the message by means of the telecommunications terminal device. The telecommunications network may be, for example, a mobile radio network. The mobile radio network may operate, for example, in accordance with the GSM standard (GSM=Global System for Mobile messages) or in accordance with the UMTS standard (UMTS=Universal Mobile Telecommunications System). The telecommunications network may also be a Local Area Network (LAN). The local area network may operate with wires or wirelessly (Wireless Local Area Network, WLAN). The telecommunications network may also be a network which covers large geographical regions (Wide Area Network, WAN). If this involves a telecommunications network via which the message is transmitted, this includes the situation that the transmission path from the telecommunications terminal device to the server comprises a plurality of different telecommunications networks. Those telecommunications networks may have different network technologies; in particular, the transmission path may comprise a plurality of different telecommunications networks of the above-mentioned network technologies.

The credit may be an indicator of whether and/or the extent to which, for example, how often or for how long, and/or which type of cost-incurring offer may be taken up by means of the telecommunications terminal device. In this instance, the credit may be set out in particular as a credit in a conventional currency, for example, Euros or US dollars, etcetera. However, it may also be a credit which is set out in another form. For example, it may be set out in the form of a notional currency, for example, in the form of “points”. The credit may have been produced by a payment (prepaid) carried out previously in order to acquire credit.

The credit may be available to the user, for example, in that it is personally associated with him. Alternatively, the credit may also be available to the user, for example, in that it is associated with the telecommunications terminal device and the user has access to the telecommunications terminal device so that he can take up a cost-incurring offer by means of the telecommunications terminal device.

Information relating to a credit which is available to the user of the telecommunications terminal device may include in particular the credit level or may consist of that information. However, the information may additionally or alternatively relate to other aspects which are connected with the credit which is available to the user. For example, such information may include an expiry date on which the credit completely or partially expires, the time of the last acquisition of credit, a difference between a maximum possible credit level and the actual, current credit level, etcetera.

In addition to the transmission of information relating to a credit which is available to the user of the telecommunications terminal device by the server to the telecommunications terminal device, the message transmitted to the server may initiate the additional transmission of additional information from the server to the telecommunications terminal device.

The initiation of the transmission of information relating to a credit which is available to a user of the telecommunications terminal device by the server to the telecommunications terminal device after the message has been received by the server may contain in particular processing of the received message by the server. That processing may comprise evaluation of the message by the server so that the server can recognise that the message received is a message which must be reacted to with the transmission of information relating to a credit which is available to the user of the telecommunications terminal device to the telecommunications terminal device. Subsequently, the server may call up the information, for example, from a database. Subsequently, the server may take corresponding steps so that the necessary transmission is carried out. To that end, it may use additional hardware resources and software resources, by means of which the transmission of the information can be carried out.

The transmission of the information from the server to the telecommunications terminal device may be carried out via a suitable telecommunications network. With regard to that telecommunications network, the explanations set out with regard to the telecommunications network via which the message can be transmitted from the telecommunications terminal device to the server apply accordingly. In particular, the transmission of the message from the telecommunications terminal device to the server and the transmission of the information by the server to the telecommunications terminal device may be carried out via the same telecommunications network.

The server may be provided by means of a provider which provides a cost-incurring offer, for the taking-up of which by means of the telecommunications terminal device the credit is useable. For example, the server may be provided by a Mobile Network Operator (MNO). The server may comprise at least one processor and at least one memory. For example, the server may comprise a RAM, in which programme code, which can be executed by the at least one processor, is loaded from another memory, for example, a hard drive, so that the server can carry out the functions assigned to it.

According to an example embodiment, the credit which is available to the user of the telecommunications terminal device is associated with an identification module which is associated with the telecommunications terminal device.

The association of the identification module with the telecommunications terminal device may involve, for example, the identification module being fixedly integrated in the telecommunications terminal device, being arranged in a removable manner in the telecommunications terminal device or also being connected—optionally in a releasable manner and optionally also so as to be able to be reconnected again—to the telecommunications terminal device.

The identification module may be any module which allows the telecommunications terminal device itself and/or a user of the telecommunications terminal device to be identified. In order to allow the identification of the telecommunications terminal device itself and/or of a user of the telecommunications terminal device, it may be sufficient for a corresponding identifier which can be read from the identification module to be stored in the identification module. An example of an identification module is a SIM card (SIM=Subscriber Identity Module). The term “SIM card” in this instance includes different configurations of SIM cards. This includes, for example, mini-SIM cards, micro-SIM cards and nano-SIM cards.

According to an example embodiment, the command which is invokable by the application is associated with a provider which provides a cost-incurring offer, for the taking-up of which by means of the telecommunications terminal device the credit is useable.

In many cases, a server which can initiate the transmission of information relating to a credit which is available to a user of a telecommunications terminal device to the telecommunications terminal device is operated by a provider which provides a cost-incurring offer, for the taking-up of which by means of the telecommunications terminal device the credit is useable. For that reason, it is possible that different providers have configured their servers differently. It may then be the case that different messages have to be received at the servers so that a transmission of information relating to a credit which is available to the user of the telecommunications terminal device is brought about, or that the message has to be selectively addressed to the server of the respective provider so that the desired information can be obtained.

If the command which is invokeable by the application is associated with the provider for which a user of the telecommunications terminal device would like to have transmitted information relating to a credit which is available to him for taking up a cost-incurring offer of the provider, it is possible by means of the command which is invokeable by the application and which is associated with the provider for a message which is tailored to this provider to be transmitted from the telecommunications terminal device to the server of the provider. In this instance, the message whose transmission from the telecommunications terminal device to the server is caused by the command is therefore dependent on the command. As a result of that message tailored to the provider, it is possible for the receipt of the message by the server of the provider to initiate the desired information transmission.

For example, the provider may be a telecommunications service provider which provides at a cost, for example, in the case of a mobile telephone, as a telecommunications terminal device, inter alia telephone call services, SMS services (SMS=Short Message Service) and data connections, including ones which operate in a packet-switching mode. Servers of such providers are configured differently depending on the provider. In order to initiate the transmission of information relating to a credit which is available to the user of the mobile telephone by the server to the mobile telephone, a message which is tailored to the respective provider or the server thereof has to be transmitted to the respective server. By means of the association of the command which is invokeable by the application with the provider, it is possible for such a message which is tailored to the provider to be transmitted from the mobile telephone to the server of the provider.

According to an example embodiment, the application is configured to select the command which is invokeable by the application and which is associated with the provider from a plurality of commands which are invokeable by the application.

It is thus possible to provide only one application according to the invention which can be used in order to initiate the transmission of information relating to a credit which is available to the user of the telecommunications terminal device without having to tailor the application to the provider which provides a cost-incurring offer, for the taking-up of which by means of the telecommunications terminal device the credit is useable. Therefore, the application can then be used in a versatile manner. The plurality of invokeable commands may be provided, for example, together with the application of a provider of the application. According to another example, the plurality of invokeable commands may also be stored in a memory outside the telecommunications terminal device, for example, on a server which the application can access, for example, via an Internet connection.

According to an example embodiment, an identification module associated with the telecommunications terminal device is provided and the identification module is associated with the provider which provides a cost-incurring offer, for the taking-up of which by means of the telecommunications terminal device the credit is useable.

Thus, it is possible to determine the respective provider by means of the identification module and a corresponding command can be selected. Therefore, the application may be configured to access the identification module in order to determine the provider which is associated with the identification module. It may be configured to select a command associated with the provider and to transmit that command on the basis of the determined provider, respectively.

Additionally or alternatively, however, there may be provision for the determination of the command, which is associated with the provider which provides a cost-incurring offer, for the taking-up of which by means of the telecommunications terminal device the credit is useable, to be carried out in a different manner.

According to an example embodiment, the application is thus configured to transmit a predetermined command or a successive plurality of predetermined commands. The predetermined command(s) may have been selected in such a manner that each of them is suited in known manner, for at least one provider of services which can be taken up by means of telecommunications terminal devices, to cause the transmission of a message from the telecommunications terminal device to a server, wherein the message is suited, after the message is received by a server, to initiate the transmission of information relating to the provider to the telecommunications terminal device. Although it is possible for a transmitted predetermined command in the case of the specific provider, for the taking-up of which by means of the telecommunications terminal device the credit is useable, not suited to initiate the transmission of information relating to the provider to the telecommunications terminal device, the successive transmission of such different, predetermined commands may be successful in one case. The application may be configured to determine the provider from the information obtained in this manner in relation to the provider and to select on the basis thereof the command which is invokeable by the application and which is associated with the provider from the plurality of commands which are invokeable by the application. It may thereby be possible to carry out the command selection without there first being known the provider for which the credit is useable for taking up an offer, for example, because there is no identification module or the identification module cannot be accessed.

The information relating to the respective provider may contain, for example, a provider identification. For example, in the case of a telephone service provider, a call number which is unique world-wide (Mobile Subscriber Integrated Services Digital Network Number, MSISDN), from which the telephone service provider is deriveable, for example, on the basis of a call number component (dialing code) which identifies it, may constitute such a provider identification.

The predetermined command(s) may for example be stored in a memory together with the programme code of the application. They may have been provided together with the application. The predetermined command(s) may also be loaded from an external source, for example, from the Internet, by the application. The predetermined command(s) may be, for example, Unstructured Supplementary Service Data (USSD) commands.

According to an example embodiment, the application is configured to receive a user input of information relating to a provider which provides a cost-incurring offer, for the taking-up of which by means of the telecommunications terminal device the credit is useable.

It is thereby possible to obtain provider information which is necessary so that the application can select from a plurality of commands which are invokeable by the application the command which is associated with the provider which provides a cost-incurring offer, for the taking-up of which by means of the telecommunications terminal device the credit is useable. That procedure may also be successful in cases in which the provider does not maintain a server which transmits information relating to the provider to the telecommunications terminal device in reaction to a suitable message. The user input may be carried out, for example, in a configuration step of the application, for example, when the application is used for the first time. The information relating to the provider may contain, for example, a call number/MSISDN in the case of a telephone service provider.

According to an example embodiment, the message is an Unstructured Supplementary Service Data (USSD) message.

USSD messages may consists of a maximum of 182 alphanumeric characters. Unlike the SMS transmission, a real-time connection is established for the duration of a USSD session for transmitting USSD messages. The connection remains open so that a bidirectional data exchange can take place. Therefore, the USSD message transmission may be considered to be more reliable than the SMS message transmission. Furthermore, the USSD message transmission is free of charge with many providers so that the transmission of information relating to a credit which is available to a user of the telecommunications terminal device by the server to the telecommunications terminal device can also be initiated and carried out if no credit is present. It is further advantageous that a large number of providers have ready servers which are configured to process USSD messages. Therefore, it is unnecessary to convert those servers and they can still react to a suitable USSD message with the initiation of a transmission of information relating to a credit which is available to the user of the telecommunications terminal device by the server to the telecommunications terminal device.

A command which is suited to cause the transmission of a USSD message from the telecommunications terminal device to a server is often referred to as a USSD command, USSD order, USSD code or GSM code. Another designation is MMI code. MMI stands for Man-Machine-Interface.

Typically, the manual input of a USSD command is begun with the character “*” and concluded with the “#” character. Those two characters enclose figures which specify the USSD command, respectively. The manual input of the command is generally concluded with a suitable user input. In the case of a mobile telephone as a telecommunications terminal device, this is usually carried out by actuating the handset key. According to the invention, the manual input of the USSD command may be dispensed with because it is invokeable by the application.

A USSD command with which a specific reaction of a server of the provider which provides a cost-incurring offer can be initiated generally varies depending on the provider. That circumstance makes it harder to use USSD commands. In many cases, users have to look up a USSD command for a specific purpose in a printed set of directions or on a website. The need for this may be dispensed with according to the invention because the USSD command is invokeable by the application.

The USSD command may itself be part of the USSD message which is transmitted on the basis of the USSD command from the telecommunications terminal device to a server of the provider.

According to an example embodiment, the transmission of the information relating to a credit which is available to the user of the telecommunications terminal device by the server to the telecommunications terminal device is carried out by means of a USSD message.

According to an example embodiment, the application is configured to transmit the command which is invokeable by the application to an interface of an operating system of the telecommunications terminal device.

In that manner, the transmission of the message from the telecommunications terminal device to the server can be caused with little implementation complexity if the operating system makes accessible, via the interface, a programme routine, by means of which the transmission of the message can be initiated.

The transmission of the command may involve invoking a programme routine of the operating system via the interface. A specific programme routine may be selected in accordance with the command, or the command may be passed to the interface or the programme routine as a parameter. For example, a USSD code can be passed as a parameter. The operating system may initiate a transmission of a USSD message from the telecommunications terminal device to the server.

According to an example embodiment, the operating system is the Android operating system.

The Android operating system provides as a so-called “ExtendedNetworkService” the function “setMmiString (string number)”. In this instance, “string number” refers to the argument which is expected by the function, in this instance a USSD command. The function “setMmiString” then ensures the transmission of the corresponding USSD message.

According to an example embodiment, the application is configured to automatically transmit the command which is invokeable by the application.

It may thereby be possible for a user of the telecommunications terminal device to cause the transmission of the command simply by starting the application and thus to initiate the transmission of the information relating to a credit which is available to him by the server to the telecommunications terminal device. An interaction of the application with the user may be unnecessary for this purpose. This may be perceived by the user to be particularly comfortable. The need for user confirmation before the transmission of the command may be unnecessary particularly when no costs are produced by transmitting the message from the telecommunications terminal device to the server and by transmitting the information relating to the credit, for example, because USSD messages which can be transmitted and received free of charge are used. In this instance, practically no relevant negative consequences exist for the user if he has inadvertently started the application and it subsequently automatically transmits the command.

According to another example embodiment, however, the application may also be configured to transmit the command which is invokable by the application after the application has started only in the event of a command of a user.

According to an example embodiment, the application is configured to specify a display of the information on the telecommunications terminal device.

In that manner, it is possible for the display of the information to be carried out as desired and optionally independently of a display which the telecommunications terminal device would carry out if the application does not specify anything else.

The fact that the application is configured to specify a display of the information on the telecommunications terminal device may, for example, include the application being configured to prevent an automatic reaction of the telecommunications terminal device, for example, of the operating system of the telecommunications terminal device, to the receipt of the information. For example, it is possible to prevent a window, in which the information is displayed, from automatically opening on a display of the telecommunications terminal device. To that end, the application may invoke, for example, the function “getMmiRunningText( )” in the case of a telecommunications terminal device with the Android operating system. That function call-up, in which no argument is passed to the function, ensures that such a window is prevented from automatically opening as a reaction to the receipt of a USSD message.

The fact that the application is configured to specify a display of the information on the telecommunications terminal device may also include, according to another example, the application being configured to extract the information from a message which is transmitted from the server to the telecommunications terminal device. Thus, for example, a selective display of the information may be carried out without additional content which is contained in the message transmitted from the server also having to be displayed. The extraction of the information may, for example, be carried out in the case of a telecommunications terminal device with the Android operating system by means of the function “getUserMessage (CharSequence text)”, the function argument designating the content to be extracted.

The specification of the display of the information may include the formatting of the display and/or the graphical configuration thereof.

The application may be configured to provide additional functionalities in addition to the previously described functionalities. For example, the application may be configured to transmit, as a result of a corresponding user input, a command which is suited to cause the transmission of a message from the telecommunications terminal device to a server, wherein the message is suited to increase the credit in accordance with a user specification when the message is received by the server.

According to an example embodiment, the application may be configured to make a functionality of the application accessible only after successful verification.

Thus, for example, it can be ensured that a safety-critical functionality of the application is made accessible only after successful verification. If, for example, the application makes available a functionality with which the credit can be increased, for which corresponding costs are naturally produced for the user of the telecommunications terminal device, that functionality may be used only after successful verification.

The verification may according to an example embodiment involve verification of an address which is associated with the telecommunications terminal device. At the address, the telecommunications terminal device can be selectively referenced in a telecommunications network. If, for example, the telecommunications terminal device is a telephone terminal device, the address may be a call number/MSISDN associated with the telephone terminal device.

According to an example embodiment, the application may be configured to cause the transmission of the address which is associated with the telecommunications terminal device to a server, wherein the server is configured to cause the transmission of a code to the address and/or to the telecommunications terminal device. The server may be configured to initiate the transmission of a release to the telecommunications terminal device after the code has been received from the telecommunications terminal device. In this instance, the receipt of the code by the server can be caused in that a user causes the application to ensure the return transmission of the code to the server. The application may be configured to make the functionality of the application accessible after the release is received.

This may have the advantage that it is possible to verify whether the address input by a user is actually associated with the telecommunications terminal device on which the application runs. Only when this is ensured is the functionality of the application made accessible.

In one exemplary scenario, the telecommunications terminal device may be, for example, a telephone terminal device and the address may contain a call number or MSISDN. If the application has a function for loading the credit, it is desirable that it is only possible with the application to load a credit which is useable with the telecommunications terminal device. A credit which is useable only with an external telecommunications terminal device is not intended to be able to be increased with the application in the exemplary scenario. Since the address of the telephone terminal device on which the application runs specifies the location to which the server transmits the code, for example, in an SMS, that code only reaches the telephone terminal device with which the respective call number/MSISDN is associated, for example, because a corresponding identification module is associated therewith. Only when the user has access to the telephone terminal device which is associated with that call number/MSISDN can it notice the code and cause the return transmission thereof to the server, whereupon the release is in turn transmitted to the telephone terminal device associated with the call number/MSISDN. On that telephone terminal device, the functionality of credit loading is then also made accessible so that a credit, which is in no way connected with the telephone terminal device on which the application is carried out, cannot be loaded in an unauthorised manner.

The code may be, for example, a code which is generated randomly or pseudo-randomly.

The release of a functionality of the application only after successful verification, in particular an address-based verification, may be particularly advantageous if no address information was automatically established—for example, by access to an identification module—but instead the address information was input by the user. This is because the user could intentionally input in this instance address information which is not associated with the telecommunications terminal device, on which the application runs, in order thus to be able to carry out unauthorised use of the application.

### BRIEF DESCRIPTION OF THE DRAWINGS

The invention is explained below with reference to four Figures, in which:

FIG. 1 is a schematic illustration of an example embodiment of a telecommunications terminal device according to the invention which comprises example embodiments of an application according to the invention and a data carrier device according to the invention.

FIG. 2 shows the telecommunications terminal device from FIG. 1 in the context of a mobile radio network and a number of network infrastructure elements of the mobile radio network, inter alia a server.

FIG. 3 is a schematic flow chart which illustrates an example embodiment of a method according to the invention which can be carried out by means of the telecommunications terminal device from FIG. 1 in the context of the mobile radio network and the network infrastructure elements from FIG. 2.

FIG. 4 is a schematic illustration of the telecommunications terminal device from FIG. 1 with the contents displayed at the end of the method illustrated in FIG. 3 on the touchscreen of the telecommunications terminal device.

### DETAILED DESCRIPTION OF THE INVENTION

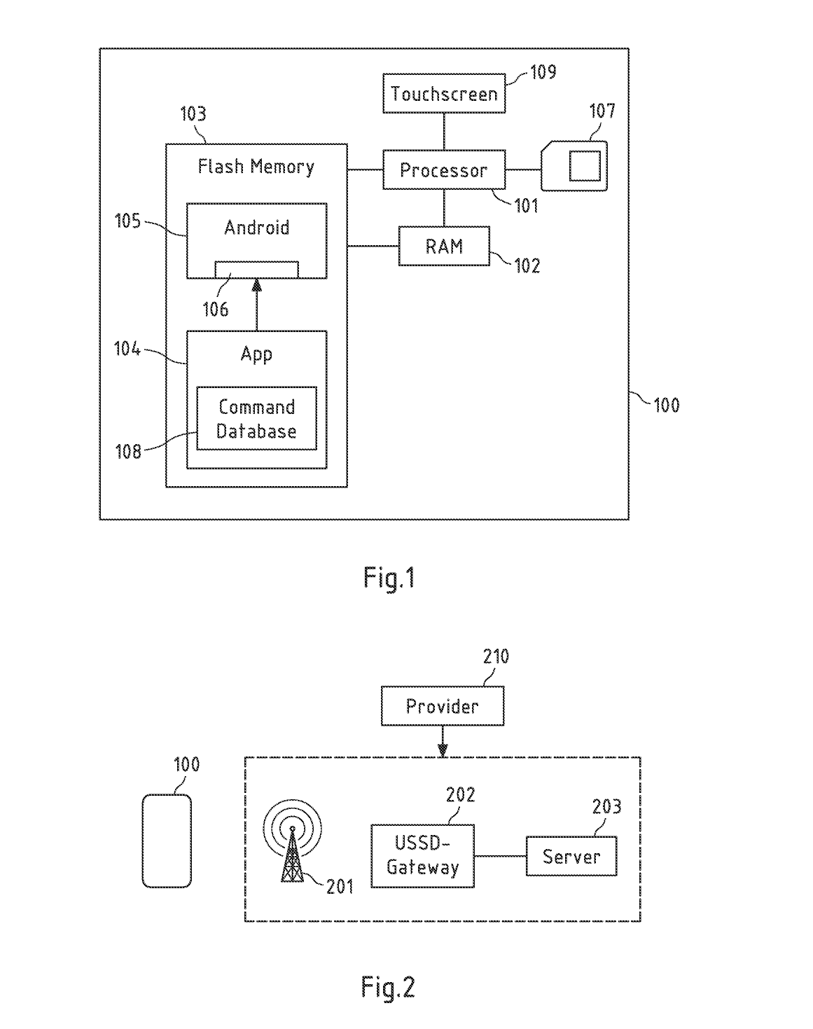

FIG. 1 is a schematic illustration of an example embodiment of a telecommunications terminal device 100 according to the invention which comprises example embodiments of an application according to the invention in the form of an App 104 and a data carrier device 103 according to the invention.

According to the example embodiment, the telecommunications terminal device is in the form of a telephone terminal device, more specifically a mobile telephone, in particular a smartphone 100. The smartphone 100 comprises inter alia a processor 101, a RAM 102 and a flash memory 103. The smartphone 100 is further provided with a touch-sensitive screen (touchscreen) 109. A SIM card 107 is further inserted in the smartphone 100. The processor 101 is connected to the RAM 102 and the flash memory 103. There is further a connection between the RAM 102 and flash memory 103, via which connection data can be transferred from the flash memory 103 to the RAM 102. The processor 101 is further connected to the SIM card 107 so that it can access the SIM card 107. It is further connected to the touchscreen 109 so that it can control it.

The App 104 is stored in the flash memory 103. A component of the App 104 is a command database 108, in which a plurality of commands is stored. The Android operating system 105 is further stored in the flash memory 103 as an additional program. The Android operating system 105 comprises an operating system interface 106.

The App 104 may have reached the flash memory 103, for example, in that it was downloaded from the Internet by a user of the smartphone 100.

The App 104 may be loaded from the flash memory 103 into the RAM 102. The App 104 comprises inter alia programme code for transmitting a command which is invokeable by the App 104 and which is suited to cause the transmission of a message from the smartphone 100 to a server, wherein the message is suited to initiate, after the message has been received by the server, the transmission of information relating to a credit which is available to the user of the smartphone 100 by the server to the smartphone 100 when the programme code is executed on the processor 101.

FIG. 2 shows the smartphone 100 from FIG. 1 in the context of a mobile radio network of a mobile radio service provider 210 and a number of network infrastructure elements 201, 202, 203 of the mobile radio network, inter alia a server 203.

The mobile radio service provider or provider 210 provides cost-incurring telephone call services, SMS services and data connections, including ones which operate packet-switching mode. In FIG. 2, the antenna 201 indicates the components of the mobile radio network which are necessary for establishing a connection between the smartphone 100 and the potential communication partners thereof. FIG. 2 further illustrates a USSD gateway 202 and a server 203. The server 203 is part of the so-called intelligent network (IN) of the provider 210.

The SIM card 107 is associated with the provider 210. A credit, which is useable for taking up cost-incurring offers of the provider 210, for example, telephone call services, SMS services and data connections, is associated with the SIM card 107. Consequently, that credit is available to a user of the smartphone 100.

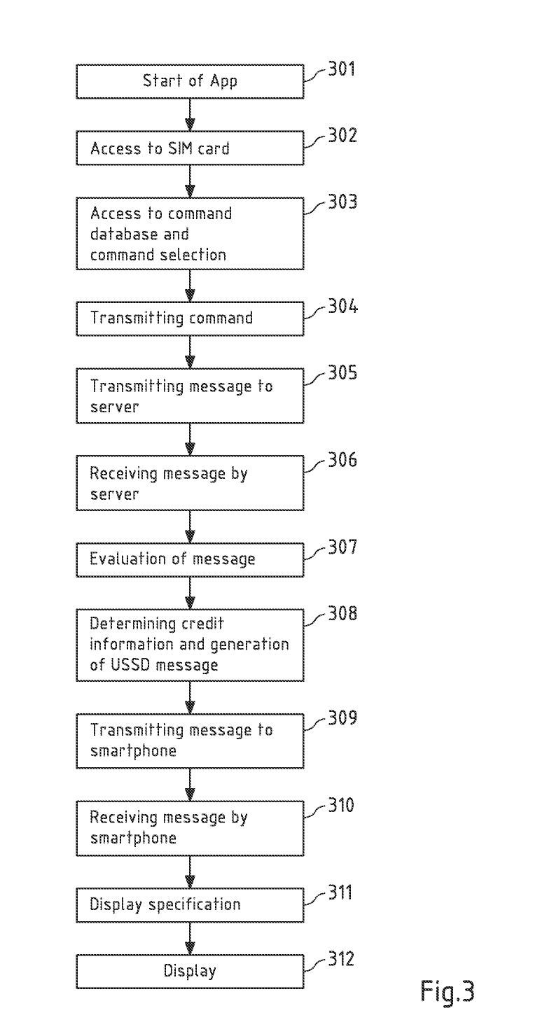

FIG. 3 is a schematic flow chart which illustrates an example embodiment of a method according to the invention which can be carried out by means of the smartphone 100 from FIG. 1 in the context of the mobile radio network and the network infrastructure elements 201, 202, 203 from FIG. 2.

In step 301, a user of the smartphone 100 starts the App 104.

The App 104 comprises programme code for accessing the SIM card 107 to determine the provider with which the SIM card 107 is associated when the programme code executed on the processor 101. To that end, a provider identification is read from the SIM card 107. That operation is carried out in step 302.

Alternatively, the App 104 may also be configured to transmit a predetermined command or a successive plurality of predetermined commands. The predetermined command(s) may have been selected in such a manner that each of them is suited to cause the transmission of a message from a smartphone to a server in known manner at least in the case of one provider of services which can be taken up by means of the smartphone, wherein the message is suited to initiate, after the message has been received by the server, the transmission of information relating to the provider to the smartphone. Although it is possible that one transmitted, predetermined command may not be suited in the case of the provider 210 to initiate the transmission of information relating to the provider 210 to the smartphone 100, for example, a call number/MSISDN which is associated with the smartphone 100 and which contains a dialing code associated with the provider 210 as a provider identification. The successive transmission of different predetermined commands of this type may be successful if—without previous knowledge of the provider 210—a predetermined command which corresponds to the provider 210 is transmitted. The App 104 may be configured to determine the provider 210 from the information which is then received relating to the provider 210 and, on that basis, to select the command which is invokeable by the App 104 and which is associated with the provider 210 from the plurality of commands which are invokeable by the App 104.

The predetermined command(s) may be stored in the flash memory 103 together with the programme code of the App 104. They may have been provided together with the App 104. However, the predetermined command(s) may also be loaded from an external source, for example, from the Internet, by the App 104. The predetermined command(s) may be, for example, USSD commands.

As an additional alternative, the App 104 may be configured to receive an user input of information relating to the provider 210. The information relating to the provider 210 may comprise, for example, a call number/MSISDN which is associated with the smartphone 100 or the SIM card 107 and which contains a dialing code which is associated with the provider 210 as a provider identification. Consequently, the provider identification of the provider 210 can also be obtained if the provider 210 does not maintain a server which transmits a provider identification to the smartphone 100 as a reaction to a corresponding message. The user input may be carried out in the step 302. It may be carried out, for example, in a configuration step of the App 104 and, for example, be necessary only when the App 104 is used for the first time.

The App 104 further comprises programme code for accessing the command database 108 when the programme code is executed on the processor 101. A plurality of commands is stored in the command database 108. Each command is stored together with a provider identification, whereby an association with the respective provider is achieved. The App 104 comprises programme code for selecting the command associated with the provider 210 from the plurality of commands stored in the command database 108 when the programme code is executed on the processor 101. The selection is carried out by the provider identification established in the step 302 being sought by the App 104 in the command database 108. If it was found in the command database 108, the App 104 selects the command associated with that provider identification in the command database 108. According to the embodiment explained here, the selected command is a USSD command. The database access operation and the selection operation are carried out in step 303.

The App 104 further comprises programme code for transmitting the previously selected command to the operating system interface 106 of the Android operating system when the programme code is executed on the processor 101. The transmission of the command is carried out by invoking the function “setMmiString (string number)” which is made accessible by means of the operating system interface 106 by the App 104. In this instance, “string number” designates the argument expected by the function. In this instance, the USSD command selected in the step 303 is passed to the function “setMmiString” as a parameter. The “setMmiString” function with the selected USSD command is invoked in step 304.

In step 305, the Android operating system 105 generates a USSD message on the basis of the USSD command passed to the “setMmiString” function. The Android operating system 105 causes hardware components of the smartphone 100 to transmit the USSD message to the server 203 of the provider 210. This is carried out inter alia by means of the network components which are indicated by the antenna 201 and by means of the USSD gateway 202.

In step 306, the server 203 receives the USSD message transmitted from the smartphone 100. Step 307 comprises the evaluation of that USSD message. In this case, the server 203 extracts from the USSD message the USSD command transmitted to the “setMmiString” function in the step 304 and can consequently determine that the user of the smartphone 100 would like to obtain information relating to a credit which is available to him for taking up cost-incurring offers of the provider 210. Furthermore, the server 203 extracts in the step 307 an identification, specifically the call number associated with the SIM card 107, from the USSD message received from the smartphone 100. On the basis of that call number, the server 203 subsequently determines in the step 308 the level of the credit which is associated with the SIM card 207 and which is available to the user of the smartphone 100. The server 203 further generates in the step 308 another USSD message in which inter alia the established credit level is contained as useful information.

In step 309, the server 203 initiates the transmission of the USSD message generated in the step 308 to the smartphone 100. To this end, it makes use of the USSD gateway 202, the network components which are indicated by the antenna 201 and additional hardware and software components. The USSD message is addressed by means of the call number which is extracted in the step 307 and which is associated with the SIM card 107.

In step 310, the smartphone 100 receives the USSD message of the server 203.

The App 104 comprises programme code for specifying a display of the credit level transmitted by the server 203 on the smartphone 100 when the programme code is executed on the processor 101. This includes the fact that the App 104 comprises programme code for preventing an automatic reaction of the smartphone 100 to the input of the USSD message in the step 310 when the programme code is executed on the processor 101. To that end, the function “getMmiRunningText( )” which makes the Android operating system 105 accessible via the operating system interface 106 is invoked by the App 104. That function call in which an argument is not transferred to the function ensures that a window, in which the content of the USSD message is displayed, is prevented from automatically opening on the touchscreen 109 as a reaction to the receipt of the USSD message.

A component of the programme code of the App 104 for specifying a display of the credit level is further programme code for extracting the credit level from the USSD message received in the step 310 when the programme code is executed on the processor 101. To that end, the function “getUserMessage (CharSequence text)” which also makes the Android operating system 105 accessible via the operating system interface 106 is invoked by the App 104. In this instance, the function argument designates the content to be extracted. Thus, a selective display of the credit level may be carried out without additional contents which are contained in the USSD message also having to be displayed.

A component of the programme code of the App 104 for specifying a display of the credit level is further programme code for formatting the display and for the graphic configuration of the display when the programme code is executed on the processor 101.

In step 312, the display is then brought about on the touchscreen 109.

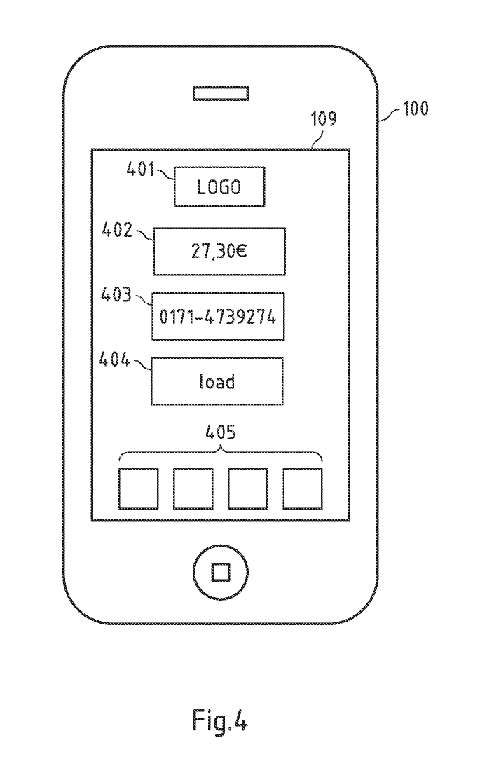

FIG. 4 is a schematic illustration of the smartphone 100 with the contents which are displayed on the touchscreen 109 in the step 312 of the method illustrated in FIG. 3.

A logo of the provider 210 is displayed in an upper region 401 on the touchscreen 109. In a region 402 underneath, the credit level extracted in the step 311 from the USSD message received in the step 310 is displayed and is in this instance, for example, ε27.30. The call number associated with the SIM card 107 is displayed in the region 403 below the region 402. The region 404 shows a button which is characterised by the word “load”. If a user of the smartphone 100 touches the region 404 on the touchscreen 109, he obtains access to a function of the App 104, with which the credit associated with the SIM card 107 for taking up cost-incurring offers of the provider 210 can be increased by a desired amount. Additional functionalities are made accessible to the user of the smartphone 100 by means of the buttons which are together designated 405. For example, one of the buttons can be used to end the App 104.

The App 104 may be configured to only display the button 404 and therefore to make the functionality of the credit loading accessible only when a verification of the call number/MSISDN which is associated with the smartphone 100 or the SIM card 107 has been successfully carried out. This may be particularly advantageous if the App 104 is configured to receive an user input of the call number/MSISDN. The App 104 may be configured to cause the transmission of the call number/MSISDN to a server, for example, the server 203 or also a different server which is not illustrated. That server may be configured to cause the transmission of a pseudo-randomly generated code by SMS to the call number/MSISDN or the smartphone 100 which can thereby be referenced. After the SMS has been opened and the code has been noticed by the user, the user can input the code into the App 104 which is configured to receive the code input for this purpose. It is further configured to cause the return transmission of the code to the server. The server is again configured to cause the transmission of a release to the smartphone 100 after the code has been received from the smartphone 100. The App 104 is configured to make the functionality of the credit loading accessible after the release is received.

Thus, it may be possible to verify whether the call number/MSISDN input by a user into the App 104 in the step 302 is actually associated with the smartphone 100, on which the App 104 runs. Only when this is ensured is the functionality of the credit loading made accessible to the App 104.

Since the call number/MSISDN associated with the smartphone 100 specifies the location to which the server transmits the code, that code only reaches the smartphone 100. Only if the user has access to the smartphone 100 can he notice the code and cause the return transmission thereof to the server, whereupon the release is again transmitted to the smartphone 100. The functionality of the credit loading is then also made accessible on the smartphone 100 so that a credit which is not connected with the smartphone 100 at all cannot be loaded in an unauthorised manner. Thus, the App 104 cannot be misused. Only the credit which is useable with the smartphone 100 or the SIM card 107 can be loaded therewith. The smartphone 100 and the App 104 cannot be used in order to increase a credit which is not useable with the smartphone 100 or the SIM card 107.

Since the App 104 in the step 303 can invoke the command associated with the provider 210, the command can be transmitted in the step 304 without an interaction of the user of the smartphone 100 with the App 104 having been necessary before the transmission of the command after the user has started the App 104 in the step 301. Therefore, the App 104 automatically transmits the command. An uncomfortable, manual input of a suitable USSD command by the user is dispensed with, which input is prone to error.

The selection of a command associated with the provider 210 makes it possible for a USSD message to be generated and to be transmitted to the server 203 which can further process it and which initiates the desired reaction of the server 203, that is to say that it transmits to the smartphone 100 in the step 309 a USSD message, in which the credit level is contained as useful information.

Since not only the command associated with the provider 210 is invokeable by the App 104, but instead the App 104 can invoke a plurality of commands which are each associated with a different provider, respectively, and selects the suitable command therefrom, the App 104 may be used in an unchanged state to call up credit information from different providers. It does not have to be tailored to a specific provider.

The use of USSD messages affords the advantage that they can be transmitted in a reliable manner and free of charge in the networks of many providers.

By using the Android operating system 105, and the consistent exploitation of the possibilities thereof, the implementation of the App 104 can be carried out with comparatively little complexity.

The specification of a display of the credit information in the step 309 makes it possible for the desired information to be displayed in an attractive and clear manner.

1. Telecommunications terminal device on which an application is provided, wherein said application is executable on said telecommunications terminal device and wherein said application is configured to transmit a command which is invokable by said application and which is suited to cause transmission of a message from said telecommunications terminal device to a server, wherein said message is suited, after said message is received by said server, to initiate transmission of information relating to a credit which is available to a user of said telecommunications terminal device by said server to said telecommunications terminal device.

2. Telecommunications terminal device according to claim 1, wherein said credit is associated with an identification module which is associated with said telecommunications terminal device.

3. Telecommunications terminal device according to claim 1, wherein said command which is invokable by said application is associated with a provider which provides a cost-incurring offer, for the taking-up of which by means of said telecommunications terminal device said credit is useable.

4. Telecommunications terminal device according to claim 3, wherein said application is configured to select said command which is invokable by said application and which is associated with said provider from a plurality of commands which are invokable by said application.

5. Telecommunications terminal device according to claim 2, wherein said identification module is associated with said provider.

6. Telecommunications terminal device according to claim 1, wherein said message is an Unstructured Supplementary Service Data message.

7. Telecommunications terminal device according to claim 1, wherein said transmission of said information relating to a credit which is available to said user of said telecommunications terminal device by said server to said telecommunications terminal device is carried out by means of an Unstructured Supplementary Service Data message.

8. Telecommunications terminal device according to claim 1, wherein said application is configured to transmit said command which is invokable by said application to an interface of an operating system of said telecommunications terminal device.

9. Telecommunications terminal device according to claim 1, wherein said operating system is the Android operating system.

10. Telecommunications terminal device according to claim 1, wherein said application is configured to automatically transmit said command which is invokable by said application.

11. Telecommunications terminal device according to claim 1, wherein said application is configured to specify a display of said information on said telecommunications terminal device.

12. Telecommunications terminal device according to claim 1, wherein said application is configured to make a functionality of said application accessible only after successful verification.

13. Data carrier device on which an application is stored, wherein said application is executable on a telecommunications terminal device and wherein said application is configured to transmit a command which is invokable by said application and which is suited to cause transmission of a message from said telecommunications terminal device to a server, wherein said message is suited, after said message is received by said server, to initiate transmission of information relating to a credit which is available to a user of said telecommunications terminal device by said server to said telecommunications terminal device.

14. Method comprising:
transmitting a command, which is invokable by an application which is executed on a telecommunications terminal device, by said application, wherein said command is suited to cause transmission of a message from said telecommunications terminal device to a server, and wherein said message is suited, after said message is received by said server, to initiate transmission of information relating to a credit which is available to a user of said telecommunications terminal device by said server to said telecommunications terminal device.
